(19) United States
(12) Patent Application Publication
(10) Pub. No.: US 2025/0105956 A1
(43) Pub. Date: Mar. 27, 2025

(54) SELECTION AND QUANTIZATION OF TIME DOMAIN COEFFICIENTS THROUGH AN EXTENDED ETYPE-II CODEBOOK

(71) Applicant: QUALCOMM Incorporated, San Diego, CA (US)

(72) Inventors: Jing Dai, Beijing (CN); Liangming Wu, Beijing (CN); Hao Xu, Beijing (CN); Peter Gaal, San Diego, CA (US); Wanshi Chen, San Diego, CA (US)

(21) Appl. No.: 18/727,283

(22) PCT Filed: Mar. 28, 2023
(86) PCT No.: PCT/CN2023/084279

§ 371 Date: Jul. 8, 2024

(30) Foreign Application Priority Data
Mar. 29, 2022 (WO) PCT/CN2022/083649

(51) Int. Cl. H04L 5/00

(52) U.S. Cl. CPC H04L 5/0023; H04L 5/0057

(57) ABSTRACT

This disclosure provides systems, methods, and devices for wireless communication that support selection and quantization of time domain coefficients through an extended eType-II codebook. In a first aspect, a method of wireless communication includes measuring, by a user equipment (UE), a bundle of channel state information reference signals (CSI-RS) to determine channel quality information across a spatial domain, a frequency domain, and a time domain. The UE generates a first bitmap identifying a first plurality of non-zero coefficients (NZCs) selected to represent a first CSI for the spatial domain and the frequency domain, and a second bitmap identifying a second plurality of NZCs selected to represent a second CSI for the time domain. The UE would then transmit one or more CSI reports including one or both of the first bitmap and the second bitmap. Other aspects and features are also claimed and described.

### CROSS-REFERENCE TO RELATED APPLICATIONS

This application claims the benefit of priority to International Patent Application No. PCT/CN2022/083649, entitled, “SELECTION AND QUANTIZATION OF TIME DOMAIN COEFFICIENTS THROUGH AN EXTENDED ETYPE-II CODEBOOK” filed on Mar. 29, 2022, which is expressly incorporated by reference herein in its entirety.

### TECHNICAL FIELD

Aspects of the present disclosure relate generally to wireless communication systems, and more particularly, to channel state information (CSI) reporting. Some features may enable and provide improved communications, including selection and quantization of time domain coefficients through an extended eType-II codebook.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes measuring, by a UE, a bundle of channel state information reference signals (CSI-RS) to determine channel quality information across a spatial domain, a frequency domain, and a time domain, generating, by the UE, a first bitmap identifying a first plurality of non-zero coefficients (NZCs) selected to represent a first CSI for the spatial domain and the frequency domain, and a second bitmap identifying a second plurality of NZCs selected to represent a second CSI for the time domain, and transmitting, by the UE, one or more CSI reports including one or both of the first bitmap and the second bitmap.

In an additional aspect of the disclosure, a UE configured for wireless communication is disclosed. The UE includes at least one processor, and a memory coupled to the at least one processor. The at least one processor is configured to measure a bundle of CSI-RS to determine channel quality information across a spatial domain, a frequency domain, and a time domain, to generate a first bitmap identifying a first plurality of NZCs selected to represent a first CSI for the spatial domain and the frequency domain, and a second bitmap identifying a second plurality of NZCs selected to represent a second CSI for the time domain, and to transmit one or more CSI reports including one or both of the first bitmap and the second bitmap.

In a UE aspect of the disclosure, an apparatus configured for wireless communication is disclosed. The UE includes means for measuring a bundle of CSI-RS to determine channel quality information across a spatial domain, a frequency domain, and a time domain, means for generating a first bitmap identifying a first plurality of NZCs selected to represent a first CSI for the spatial domain and the frequency domain, and a second bitmap identifying a second plurality of NZCs selected to represent a second CSI for the time domain, and means for transmitting one or more CSI reports including one or both of the first bitmap and the second bitmap.

In an additional aspect of the disclosure, a non-transitory computer-readable medium stores instructions that, when executed by a processor, cause the processor to perform operations including measuring a bundle of CSI-RS to determine channel quality information across a spatial domain, a frequency domain, and a time domain, generating a first bitmap identifying a first plurality of NZCs selected to represent a first CSI for the spatial domain and the frequency domain, and a second bitmap identifying a second plurality of NZCs selected to represent a second CSI for the time domain, and means for transmitting one or more CSI reports including one or both of the first bitmap and the second bitmap.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating example details of an example wireless communication system according to one or more aspects.

FIG. 2 is a block diagram illustrating examples of a base station and a user equipment (UE) according to one or more aspects.

FIG. 3 is a block diagram illustrating a UE communicating a CSI report to a base station including a graphical representation of the Nₜ×N₃ precoder matrix W.

FIG. 4 is a block diagram illustrating a CSI feedback process between a UE and base station that supports selection of time domain coefficients through an extended eType-II codebook according to one or more aspects.

FIG. 5 is a flow diagram illustrating an example process that supports selection of time domain coefficients through an extended eType-II codebook according to one or more aspects.

FIG. 6 is a block diagram illustrating a bitmap identifying NZC selection for the frequency-, spatial-, and time domain bases configured for the UE that supports selection of time domain coefficients through an extended eType-II codebook according to one or more aspects of the present disclosure.

FIG. 7 is a block diagram graphically representing a coefficient power amplitude over each beam, as measured by a UE configured to support selection and quantization of time domain coefficients through an extended eType-II codebook according to one or more aspects of the present disclosure.

FIG. 8 is a block diagram of an example UE that supports selection of time domain coefficients through an extended eType-II codebook.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support selection and quantization of time domain coefficients through an extended cType-II codebook. Particular implementations of the subject matter described in this disclosure may be implemented to realize one or more of the following potential advantages or benefits. In some aspects, the present disclosure provides techniques for measuring a bundle of channel state information reference signals (CSI-RS) to determine channel quality information across a spatial domain, a frequency domain, and a time domain. The techniques further support the UE generating a first bitmap identifying a first plurality of non-zero coefficients (NZCs) selected to represent a first CSI for the spatial domain and the frequency domain, and a second bitmap identifying a second plurality of NZCs selected to represent a second CSI for the time domain, and then transmitting, by the UE, one or more CSI reports including one or both of the first bitmap and the second bitmap. Such techniques may allow improved channel quality management that includes time domain variations in the channel characteristics between the base stations and served UEs. The additional time domain CSI allows improved channel state management including better management of modulation and coding scheme (MCS), precoding matrix, rank, beam forming, and the like. Including such time domain variations in channel characteristics in the CSI reporting allows for improved service to high-Doppler (e.g., fast moving) UEs.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “mmW” band.

The frequencies between FR1 and FR2 are often referred to as mid-band frequencies. Recent 5G NR studies have identified an operating band for these mid-band frequencies as frequency range designation FR3 (7.126 GHz-24.25 GHz). Frequency bands falling within FR3 may inherit FR1 characteristics and/or FR2 characteristics, and, thus, may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2x (52.6 GHz-71 GHz), FR4 (71 GHz-114.25 GHz), and FR5 (114.25 GHz-275 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmW” or the like if used herein may broadly represent frequencies that may include mid-band frequencies, may be within FR2, FR2x, FR4, and/or FR5, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmW transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmW components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

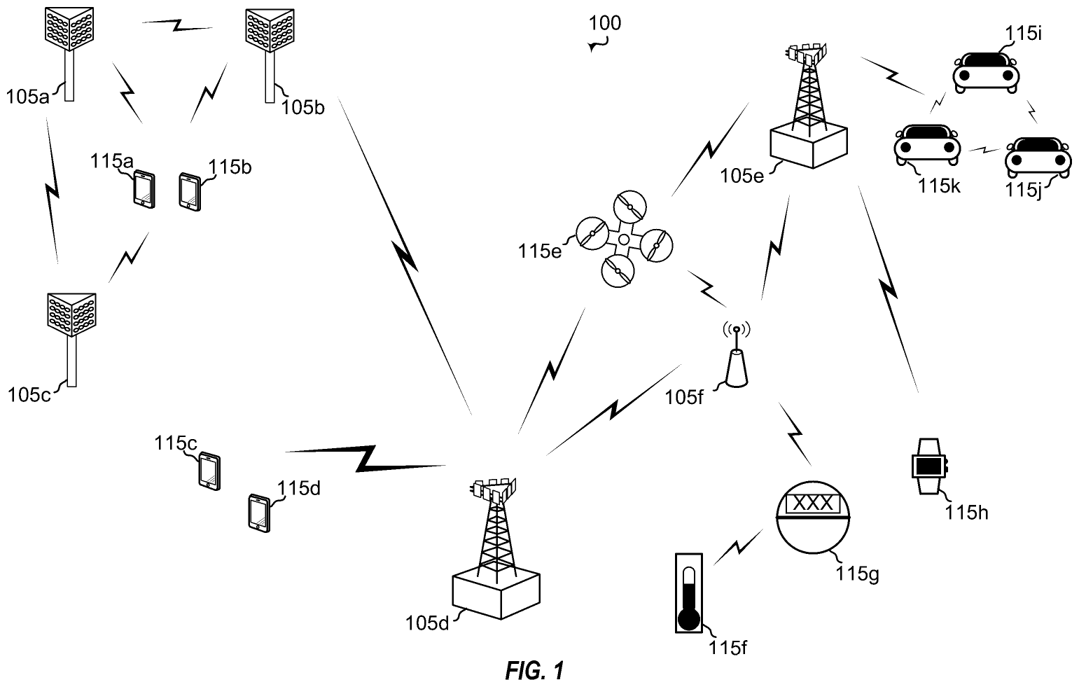

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105c are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D) beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105c, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

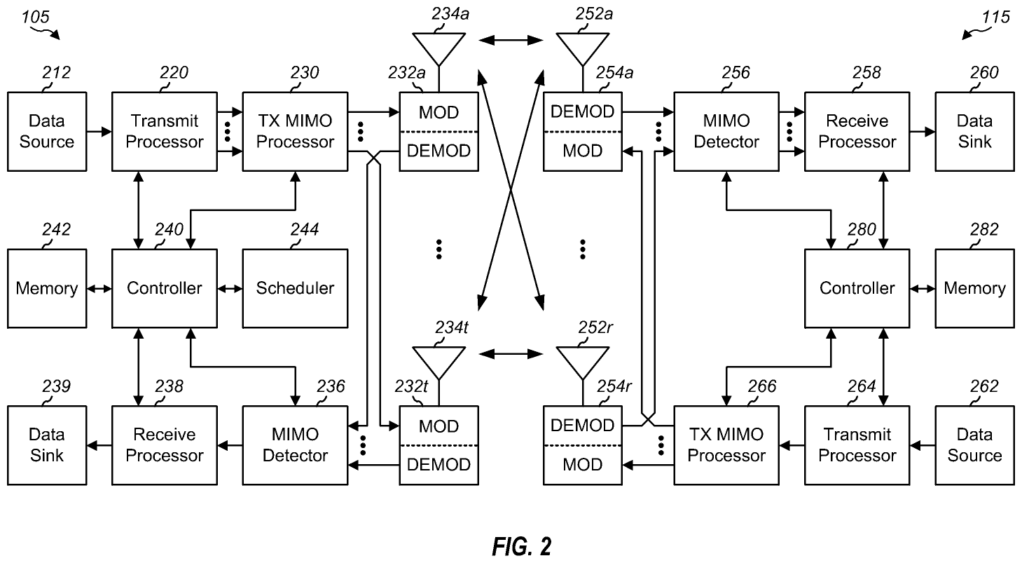

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repcat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

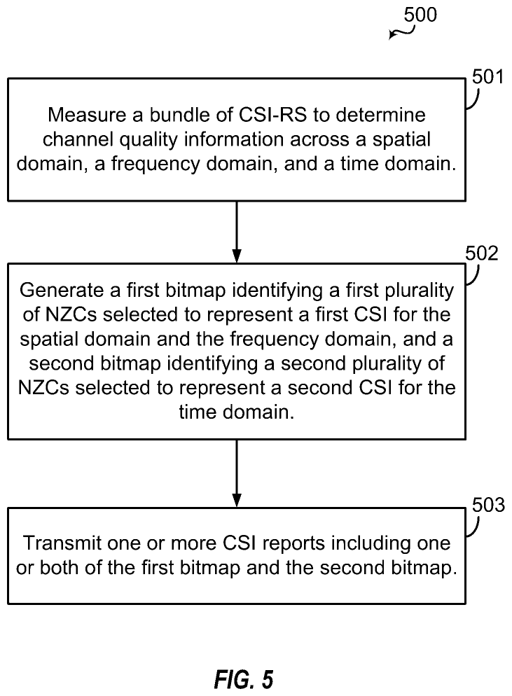

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

Use of a medium-sensing procedure to contend for access to an unlicensed shared spectrum may result in communication inefficiencies. This may be particularly evident when multiple network operating entities (e.g., network operators) are attempting to access a shared resource. In wireless communications system 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

It has been suggested to investigate CSI reporting enhancements for high/medium UE velocities by exploiting time domain correlation/Doppler domain information to assist in downlink precoding, targeting FR1, as a 3GPP Release 16 (Rel-16)/Release 17 (Rel-17) Type-II codebook refinement, without modification to the spatial and frequency domain basis. UEs could use this codebook refinement in reporting of time-domain channel properties measured of the channel state information-reference signal (CSI-RS), including CSI-RS for tracking.

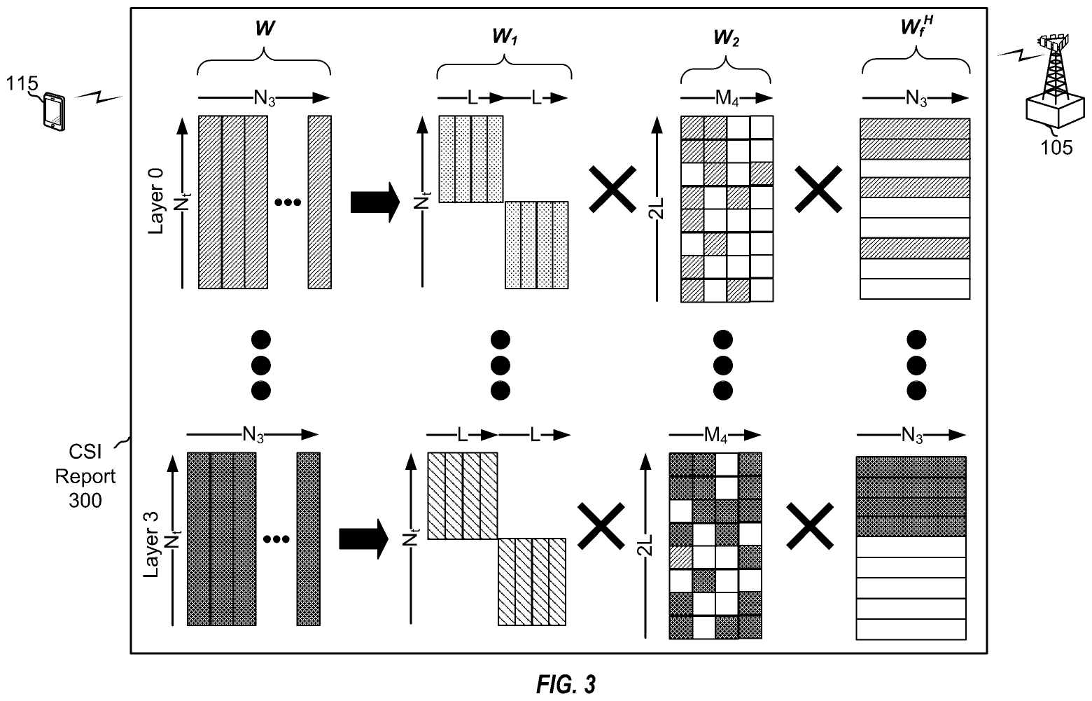

FIG. 3 is a block diagram illustrating a UE 115 communicating a CSI report 300 to base station 105 including a graphical representation of the Nₜ×N₃ precoder matrix W. UE 115 may measure a bundle of CSI-RS transmitted from base station 105 to determine CSI feedback. For example, CSI report 300 may include a channel quality indicator (CQI), rank indicator, and a precoding matrix indicator (PMI) associated with codebook sets. The Rel-16 eType-II codebook supports up to rank-4, in which, for each layer, the precoder across a number of N₃ (PMI-) subbands may be represented by an Nₜ×N₃ matrix W according to the equation:

$$W = {W}_{1} \times {\tilde{W}}_{2} \times {W}_{f}^{H} \qquad ( 1 )$$

Where, the spatial domain bases, W₁ (discrete Fourier transform (DFT) bases), may be represented as an Nₜ×2L matrix. W₁ is common over all layers (Layer 0-3), where Nₜ=2N₁O₁N₂O₂ (the number of transmit antennas—with O₁ and O₂ oversampling) and L={2,4,6} (number of beams) are RRC-configured. The frequency domain bases, W_{f}^{H} (DFT bases), may be represented by an M×N₃ matrix. W_{f}^{H} is layer-specific, where M (number of frequency domain bases) is rank-pair specific, in which M₁=M₂ for rank={1,2}, and M₃=M₄ for rank={3,4}. M₁ or M₃ is also RRC-configured. The coefficients portion of W, \tilde{W}₂, may be represented by a 2L×M matrix. \tilde{W}₂ is also layer-specific, where, for each of Layers 0-3, up to K₀ non-zero coefficients may be reported, where K₀ is RRC-configured. Across all of Layers 0-3, UE 115 may report up to 2K₀ non-zero coefficients (NZCs), in which unreported coefficients may be set to zeros.

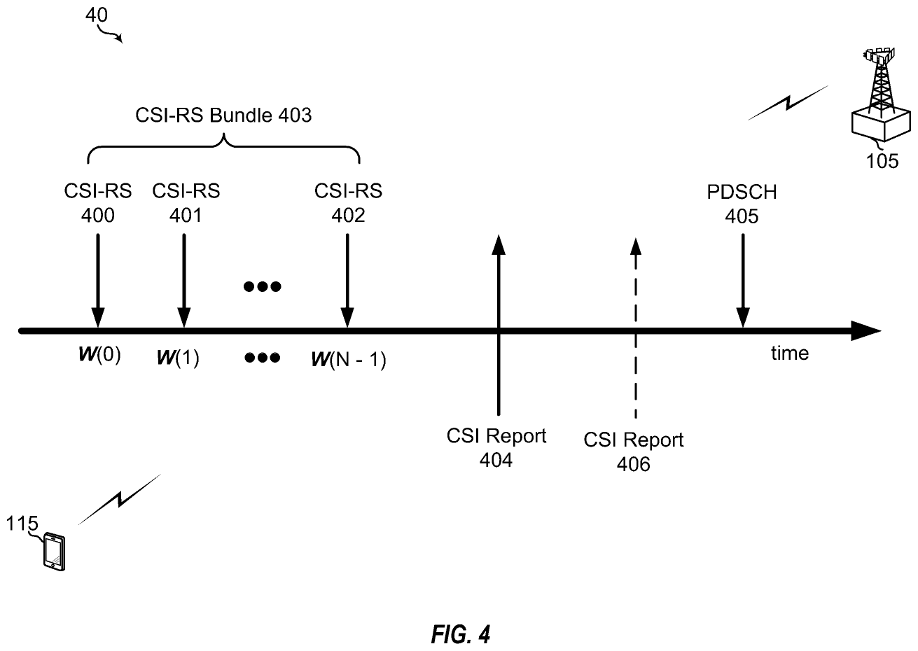

FIG. 4 is a block diagram illustrating CSI feedback process 40 between UE 115 and base station 105 that supports selection of time domain coefficients through an extended eType-II codebook according to one or more aspects. Base station 105 may transmit CSI-RS 400-402 as CSI bundle 403 for CSI feedback process 40. UE 115 measures characteristics of the channel of CSI bundle 403 to determine the CSI feedback via CQI, RI, and PMI with a precoder associated with a codebook. UE 115 includes the CSI feedback in CSI report 404 to base station 105. In a CSI report for joint spatial-/frequency-/time-domain CSI feedback, such as CSI report 404, a time-variant CSI, with a coefficient matrix \tilde{W}₂(n) may vary at a time instance n, in which each coefficient may be denoted as \tilde{w}_{i,m}(n), i=(0, 1, . . . , 2L−1, m=0, 1, . . . , M−1). The coefficients can be modeled according to the equation:

$${\tilde{w}}_{i , m} ( n ) = {\sum }_{q = 0}^{D - 1} {d}_{q} ( n ) \cdot {γ}_{q , i , m} , \qquad ( 2 )$$

Where d_{q}(n), q=0, 1, . . . , D−1 is related to the q^{th} time domain basis, d_{q}=[d_{q}(0), d_{q}(1), . . . , d_{q}(N′−1)]^{T}, where the length N′ of d_{q} is the furthest time instance for CSI reporting for CSI bundle 403. The time domain basis matrix Wₜ=[d₀, d₁, . . . , d_{D-1}] may be represented as an N′×D matrix. The determination of time domain bases may be calculated using a number of different basis technologies, such as DFT bases, Slepian bases, eigenvector decomposition (EVD) bases, and the like. γ_{q,i,m} represents the combination coefficient for the q^{th} time basis, i^{th} spatial basis, m^{th} frequency basis. UE 115 measures and reports γ_{q,i,m} based on the N bundled CSI-RS occurrences (CSI bundle 403), in addition to W₁ and W_{f}^{H}. Matrices W₁ and W_{f}^{H} are assumed to be time-invariant across the N′ time instances, where N′>N is assumed for CSI extrapolation or channel prediction.

It should be noted that determining the time domain basis using EVD bases would be of the time domain covariance matrix, which would additionally prompt UE 115 to also report a time domain covariance matrix.

In the Rel-16 eType-II CSI codebook, for NZC selection in \tilde{W}₂, a 2LM-bit bitmap may be used for each layer. 2L represents the number of selected spatial domain bases (e.g., beams), M represents the number of frequency domain bases according to configuration and channel rank. The additional NZC selection for joint spatial-/frequency-/time domain CSI reporting may result in a large overhead for the coefficient bitmaps. With the number of time domain bases denoted as D, NZC selection would then use 2LMD bits for each layer. In addition, as the refinement to the Rel-16/17 Type-II codebook is desirable to be implemented without significant modifications to spatial- and frequency domain bases, a more efficient solution may include adding time domain (Doppler domain) features of the CSI reporting in addition to the Rel-16 eType-II codebook. In order to secure a smaller overhead with NZC selection and also fewer modifications to the Rel-16 eType-II codebook, NZC selection for time domain CSI coefficients may be based on the already-existing spatial- and frequency domain coefficients in the Rel-16 eType-II CSI codebook.

FIG. 5 is a flow diagram illustrating an example process 500 that supports selection of time domain coefficients through an extended eType-II codebook according to one or more aspects. Operations of process 500 may be performed by a UE, such as UE 115 described above with reference to FIG. 1, 2, or 8. For example, example operations (also referred to as “blocks”) of process 500 may enable UE 115 to support selection of time domain coefficients through an extended eType-II codebook.

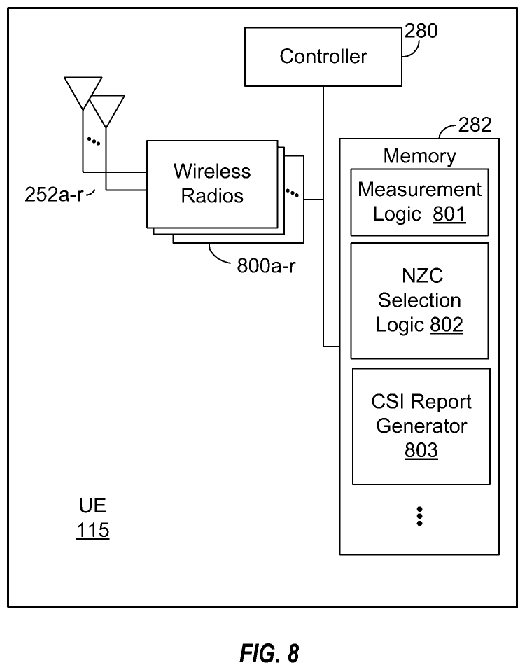

Process 500 may be described with respect to FIG. 8. FIG. 8 is a block diagram of an example UE 115 that supports selection of time domain coefficients through an extended eType-II codebook. UE 115 may be configured to perform operations, including the blocks of a process described with reference to FIG. 5. In some implementations, UE 115 includes the structure, hardware, and components shown and described with reference to UE 115 of FIGS. 1-2. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 800a-r and antennas 252a-r. Wireless radios 800a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include measurement logic 801, NZC selection logic 802, and CSI report generator 803. Measurement logic 801 may, upon execution by controller 280, be configured to provide UE 115 with signal measurement functionality, such as measuring the signal and channel characteristics of CSI-RS received at UE 115 or by measuring the power amplitude of selected NZC. The implementation of such measurement functionality on execution of the code or instructions of measurement logic 801 may be referred to herein as the “execution environment” of measurement logic 801. NZC selection logic 802 may, upon execution by controller 280, be configured to provide UE 115 with the functionality according to the various aspects described herein for selection of time domain NZCs for time domain CSI feedback in addition to the selection of spatial- and frequency domain NZCs for spatial- and frequency domain CSI feedback. CSI report generator 803 may, when executed by controller 280 be configured to provide UE 115 with the functionality to generate one or more CSI reports that include coefficient bitmaps that identify NZCs for spatial-, frequency-, and time domain CSI feedback in addition to identification of SCI and a quantization relative to the strongest coefficients in the spatial-, frequency-, and time domains. UE 115 may receive signals from or transmit signals to one or more network entities, such as base station 105 of FIGS. 1-4.

In block 501, a UE measures a bundle of CSI-RS to determine channel quality information across a spatial domain, a frequency domain, and a time domain. A UE, such UE 115, may detect signals, such as CSI-RS, received via antennas 252a-r and wireless radios 800a-r. UE 115 may then, under control of controller 280, execute measurement logic 801, stored in memory 282. The execution environment of measurement logic 801 provides UE 115 the functionality to measure the signal and channel characteristics of the bundle of CSI-RS. UE 115 may then determine the channel quality information across the spatial-, frequency-, and time domains based on the channel measurements.

In block 502, the UE generates a first bitmap identifying a first plurality of NZCs selected to represent a first CSI for the spatial domain and the frequency domain, and a second bitmap identifying a second plurality of NZCs selected to represent a second CSI for the time domain. UE 115 may, under control of controller 280, execute NZC selection logic 802 and CSI report generator 803, stored in memory 282. The execution environments of NZC selection logic 802 and CSI report generator 803 provides UE 115 the functionality to select the NZC for generating a first bitmap identifying CSI feedback for the spatial- and frequency domains, and to select the NZC for generating a second bitmap identifying the CSI feedback for the time domain. The generated spatial-, frequency-, and time domain bitmaps may be compiled with additional channel quality information into one or more CSI reports.

As noted in greater detail below, NZC selection logic 802 may be configured to select time domain NZCs using various alternative schemes across all layers. For example, UE 115, within the execution environment of NZC selection logic 802, may select time domain NZCs on a per beam, per delay basis; on a per beam basis; on a per delay basis; commonly across all beams and delays for each time domain basis, or on a per beam, per delay, per time domain basis.

In block 503, the UE transmits one or more CSI reports including one or both of the first bitmap and the second bitmap. Within the execution environment of CSI report generator 803, once UE 115 completes generation of the CSI report including the bitmaps identifying NZCs for the spatial- and frequency domains and the time domain and the additional channel quality information, it may then transmit the one or more CSI reports via wireless radios 800a-r and antennas 252a-r. In one example implementation, UE 115 may transmit a CSI report that includes the bitmap for the spatial- and frequency domain NZCs in a first field or part of the CSI report and the bitmap for the time domain NZCs in a second field or part of the same CSI report. In another example implementation, UE 115 may transmit a first CSI report that includes the bitmap for the spatial- and frequency domain NZCs and a second CSI report that includes the bitmap for the time domain NZCs. The second CSI report may further include a linkage to the first CSI report, such that the receiving base station may combine the bitmaps for all NZCs across the spatial-, frequency-, and time domains in assessing and managing the transmission characteristics for communications between the base station and UE 115.

The various aspect of the present disclosure may allow improved channel quality management that includes time domain variations in the channel characteristics between the base stations and served UEs. The additional time domain CSI allows improved channel state management including better management of modulation and coding scheme (MCS), precoding matrix, rank, beam forming, and the like. Including such time domain variations in channel characteristics in the CSI reporting allows for improved service to high-Doppler (e.g., fast moving) UEs.

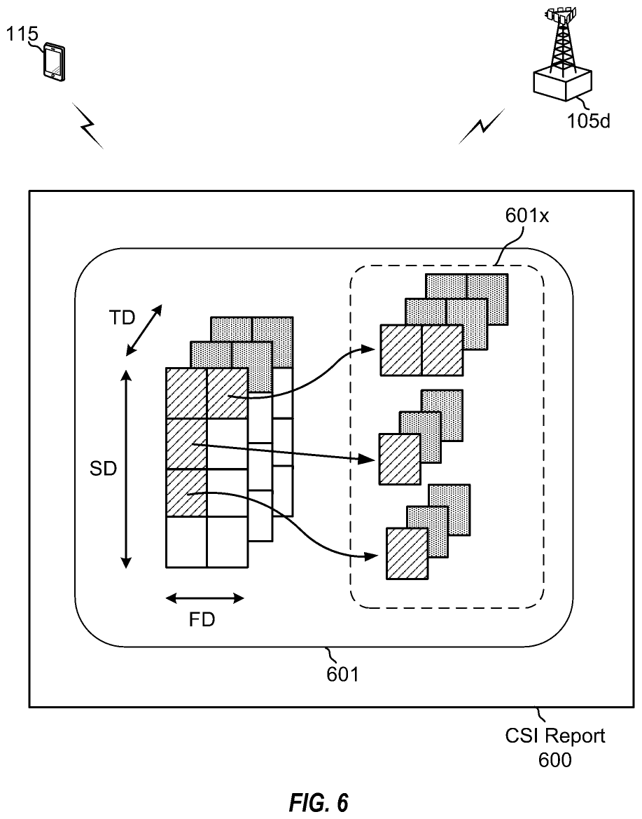

FIG. 6 is a block diagram illustrating a bitmap 601 within CSI report 600 identifying NZC selection for the frequency-, spatial-, and time domain bases configured for UE 115 which supports selection of time domain coefficients through an extended eType-II codebook according to one or more aspects of the present disclosure. UE 115 would generate CSI report 600 including bitmap 601 using the measurement of CSI-RS from base station 105. UE 115 then transmits CSI report 600 to base station 105. As illustrated, bitmap 601 a number of rows representing a number of beams in the spatial domain, a number of columns representing a number of delays in the frequency domain, and a number of “overlapping” time slices representing a number of time domain bases configured in the time domain. The highlighted segments in bitmap 601, which are illustrated in a detailed breakout 601x, represent the NZC selections over the spatial-, frequency-, and time domains. The selection of time domain CSI feedback may be be based on the selected NZCs in spatial- and frequency domains (e.g., based on the selected NZCs per row/beams and per column/delays of bitmap 601). In the Rel-16 eType-II codebook, up to K₀=[β×2LM₁] NZCs may be selected for one layer, while a total of 2K₀ NZC's may be selected across all layers. Thus, the reported total number of NZCs, K_{NZ}^{tot}, may be represented according to K_{NZ}^{tot}≤2K₀.

In a first optional aspect of the present disclosure, UE 115 may select time domain coefficients on a per beam, per delay basis. Thus, a time domain NZC may be selected for each NZC selected for beams in the spatial domain and each NZC selected for delays in the frequency domain, across all layers. For the reported K_{NZ}^{tot} NZCs in spatial- and frequency domains (eTypeII codebook) across all layers, an additional K_{NZ}^{tot}(D−1) bits may be used for the bitmap indication of NZC selection time domain coefficients, where K_{NZ}^{tot} represents each NZC selected in the spatial- and frequency domains, and D represents the number of time domain bases configured for the time domain for UE 115. As illustrated, there are four NZCs selected in the spatial- and frequency domains in the first time basis, K_{NZ}^{tot}=4. Three total time domain bases are illustrated in bitmap 601 (e.g., D)=3). Therefore, under the first optional aspect, UE 115 would use an additional 8 bits (4(3−1)) to identify the time domain NZCs across all configured time domain bases in bitmap 601.

In a second optional aspect of the present disclosure, UE 115 may select time domain coefficients on a per beam basis. Thus, a time domain NZE may be selected for each NZC selected for beams in the spatial domain across all layers. As noted above, the beams are identified by the number of rows in \tilde{W}₂ that contain at least one NZC as L_{NZ}^{tot}, across all layers. In such optional aspect, an additional L_{NZ}^{tot}(D−1) bits may be used for indication of NZC selection for time domain coefficients in bitmap 601. As illustrated, there NZCs are selected in three beams/columns in the spatial domain, L_{NZ}^{tot}=3 and D−3. Therefore, under the second optional aspect, UE 115 would use an additional 6 bits (3(3−1)) to identify the time domain NZCs across all configured time domain bases in bitmap 601.

It should be noted that, under the second optional aspect, two NZCs identified within the same beam (e.g., within a same row of \tilde{W}₂ for one layer) are associated with the same indication of NZC selection for time domain coefficients. For example, while there is an NZC in the first row/beam for each of the two columns/delays of the frequency domain, a single NZC selection indication is identified for the time domain across all layers.

In a third optional aspect of the present disclosure, UE 115 may select time domain coefficients on a per delay basis. Thus, a time domain NZC may be selected for each NZE selected for delays in the frequency domain across all layers. The delays are identified by the number of columns in \tilde{W}₂ that contain at least one NZC as M_{NZ}^{tot}, across all layers. In such optional aspect, an additional M_{NZ}^{tot}(D−1) bits may be used for indication of NZC selection for time domain coefficients in bitmap 601. As illustrated, NZCs are selected in two delays/columns of bitmap 601, M_{NZ}^{tot}=2 and D=3. Therefore, under the third optional aspect, UE would use an additional 4 bits (2(3−1)) to identify the time domain NZCs across all configured time domain bases in bitmap 601.

As noted above with respect to the second optional aspect, any multiple NZC identified within the same delay (e.g., within a same column of \tilde{W}₂ for one layer) are associated with the same indication of NZC selection for time domain coefficients. For example, while there is an NZC in the first column/delay for three rows/beams of the spatial domain, a single NZC selection indication is identified for the time domain across all layers.

In a fourth optional aspect of the present disclosure, UE 115 may select time domain coefficients commonly across all beams and delays. Thus, a time domain NZC may be selected if any NZC is selected for a beam or delay across the spatial- or frequency domains across all layers. For example, for the first time domain basis of bitmap 601, at least one NZC is selected, whether on a beam or delay. One time domain NZC would be selected for the at least one NZC selected on a beam or delay of the first time domain basis. Because one time domain NZC is selected for any NZC identified in a beam or delay of each configured time domain basis, UE 115 may use an additional D−1 bits for indication of NZC selection of time domain coefficients in bitmap 601.

In a fifth optional aspect of the present disclosure, UE 115 may select time domain coefficients on a more granular basis, by selecting a time domain NZC for any beam, delay, or time domain basis. Such a selection criteria may use 2LMD bits for each layer (e.g., 2LMD*RI bits across all layers, where RI (rank indicator) is the number of layers). Thus, an additional 2LM(D−1) bits may be used for each layer (additional 2LM(D−1)*RI bits across all layers).

In one example implementation of the fifth optional aspect, assuming an RI=1 (single layer), with 2L=4 (spatial domain), M=2 (frequency domain), and D=3 (time domain), UE 115 would use an additional 16 bits (4*2(3−1)*1) to identify the time domain NZCs across all configured time domain bases in bitmap 601. In another example implementation of the fifth optional aspect, assuming an RI=2 (two layers), UE 115 would use an additional 32 bits (4*2(3−1)*2) to identify the time domain NZCs across all configured time domain bases in bitmap 601.

It should be noted that the example implementations which include numbers of configured beams, L, number of configured frequency domain bases, M, the number of configured time domain bases, D, and the rank indicators, RI, are merely examples. It should be understood that different numbers of beams, frequency domain and time domain bases may be configured for a given network. The different configured values of L, M, D, and RI would result in different numbers of additional bits for bitmap 601 using the same formulas described above.

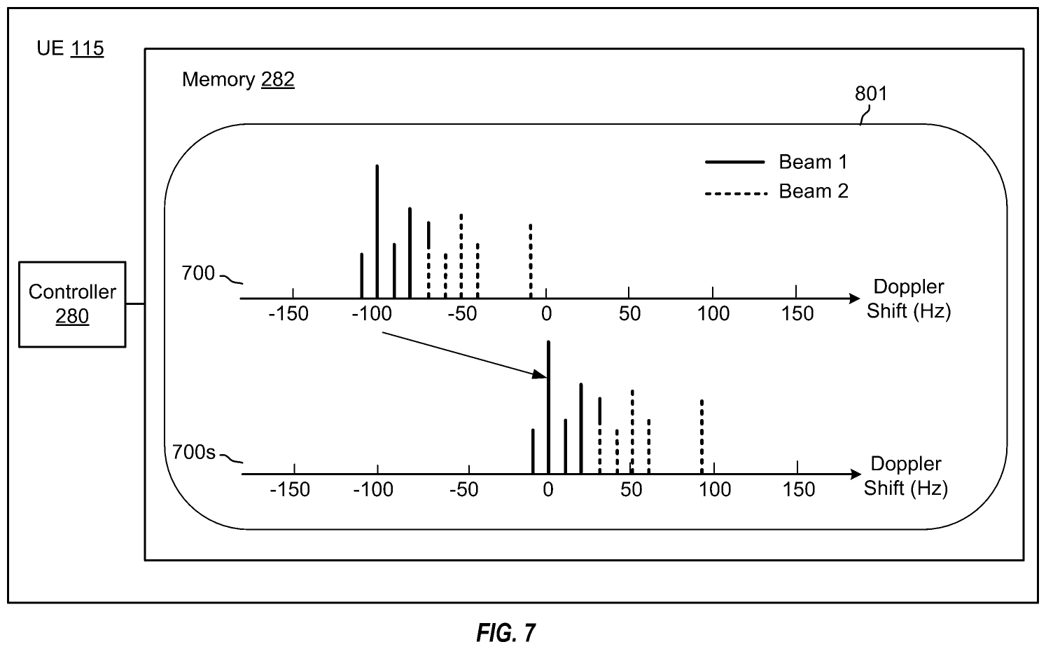

FIG. 7 is a block diagram graphically representing a coefficient power amplitude over each beam, as measured by UE 115 configured to support selection and quantization of time domain coefficients through an extended eType-II codebook according to one or more aspects of the present disclosure. As noted above, with respect to FIG. 8, UE 115 includes memory 282. Under control of controller 280, UE 115 executes measurement logic 801, within memory 282. Within the execution environment of measurement logic 801, UE 115 quantifies the amplitude measurements of the NZCs. Amplitude measurement 700 identifies the raw signal amplitude of the NZCs over beams 1 and 2. The strongest coefficient for the time domain CSI feedback can be aligned at zero-Doppler time domain basis (which may be defined as time domain or Doppler basis 0). Amplitude measurement 700s represents the linear phase shifting of the strongest coefficient to align with Doppler basis 0. In one example implementation, this may be equivalent to multiplying each coefficient element within each basis d_{q}=[d_{q}(n), n=0, 1, . . . , N′−1]^{T} with a linear phase shift

$${e}^{- j 2 π {f}_{D , {p}_{strongest}} {nT}_{sample}}$$

over the sampled time instances n=0, 1, . . . , where f_{D,p}_{_{strongest}} represents the Doppler shift associated with the strongest coefficient, and Tₛₐₘₚₗₑ represents the time interval of the sampled instances of CSI reference resources for reporting. For \tilde{W}₂(n) at time instances n, the multiplicative factor may be a constant, and, thus, a base station would not need to know it. UE 115 may then use ┌log₂ 2L┐ bits in a CSI report, such as CSI reports 404 and 600, to indicate the strongest coefficient indicator (SCI) of the time domain for each layer.

Differential quantization based on SCI may be extended to time domain quantization in the eType-II codebook. The ┌log₂ 2L┐ SCI bits may also indicate which polarization is stronger. Tables 1 and 2 below represent coefficient matrices for Doppler basis 0 (Table 1) and the additional Doppler bases (Table 2). A reference power, p_{ref}, may be identified for the coefficient amplitudes of the weaker polarization associated with all time domain bases. The weaker polarizations are identified for the coefficients in the matrix rows above the strongest coefficient, where the stronger polarizations are in the matrix rows from the strongest coefficient and below.

Based on the strongest amplitude, differential quantization p_{i,m}, p_{i,m}′, . . . (i=0, 1, . . . , 2L−1, m=0, 1, . . . , M−1) may be identified for all NZCs associated with all time domain bases for each laver.

TABLE 1
$[ \begin{matrix}{p}_{ref} {p}_{0 , 0} {e}^{j {ϕ}_{0 , 0}} & {p}_{ref} {p}_{0 , 1} {e}^{j {ϕ}_{0 , 1}} & … & {p}_{ref} {p}_{0 , M - 1} {e}^{j {ϕ}_{0 , M - 1}} \\ {p}_{ref} {p}_{1 , 0} {e}^{j {ϕ}_{1 , 0}} & {p}_{ref} {p}_{1 , 1} {e}^{j {ϕ}_{0 , 1}} & … & {p}_{ref} {p}_{1 , M - 1} {e}^{j {ϕ}_{1 , M - 1}} \\ ⋮ & ⋮ & ⋱ & ⋮ \\ {p}_{ref} {p}_{L - 1 , 0} {e}^{j {ϕ}_{L - 1 , 0}} & {p}_{ref} {p}_{L - 1 , 1} {e}^{j {ϕ}_{L - 1 , 1}} & … & {p}_{ref} {p}_{L - 1 , M - 1} {e}^{j {ϕ}_{L - 1 , M - 1}} \\ 1 & {p}_{L , 1} {e}^{j {ϕ}_{L , 1}} & … & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & … & {p}_{L + 1 , M - 1} {e}^{j {ϕ}_{L + 1 , M - 1}} \\ ⋮ & ⋮ & ⋱ & ⋮ \\ {p}_{2 L - 1 , 0} {e}^{j {ϕ}_{2 L - 1 , 0}} & {p}_{2 L - 1 , 1} {e}^{j {ϕ}_{2 L - 1 , 1}} & … & {p}_{2 L - 1 , 1} {e}^{j {ϕ}_{2 L - 1 , M - 1}}\end{matrix} ]$

TABLE 2
$[ \begin{matrix}{p}_{ref} {p}_{0 , 0}^{′} {e}^{j {ϕ}_{0 , 0}^{′}} & {p}_{ref} {p}_{0 , 1}^{′} {e}^{j {ϕ}_{0 , 1}^{′}} & … & {p}_{ref} {p}_{0 , M - 1}^{′} {e}^{j {ϕ}_{0 , M - 1}^{′}} \\ {p}_{ref} {p}_{1 , 0}^{′} {e}^{j {ϕ}_{1 , 0}^{′}} & {p}_{ref} {p}_{1 , 1}^{′} {e}^{j {ϕ}_{0 , 1}^{′}} & … & {p}_{ref} {p}_{1 , M - 1}^{′} {e}^{j {ϕ}_{1 , M - 1}^{′}} \\ ⋮ & ⋮ & ⋱ & ⋮ \\ {p}_{ref} {p}_{L - 1 , 0}^{′} {e}^{j {ϕ}_{L - 1 , 0}^{′}} & {p}_{ref} {p}_{L - 1 , 1}^{′} {e}^{j {ϕ}_{L - 1 , 1}^{′}} & … & {p}_{ref} {p}_{L - 1 , M - 1}^{′} {e}^{j {ϕ}_{L - 1 , M - 1}^{′}} \\ 1 & {p}_{L , 1}^{′} {e}^{j {ϕ}_{L , 1}^{′}} & … & {p}_{L , M - 1}^{′} {e}^{j {ϕ}_{L , M - 1}^{′}} \\ {p}_{L + 1 , 0}^{′} {e}^{j {ϕ}_{L + 1 , 0}^{′}} & {p}_{L + 1 , 1}^{′} {e}^{j {ϕ}_{L + 1 , 1}^{′}} & … & {p}_{L + 1 , M - 1}^{′} {e}^{j {ϕ}_{L + 1 , M - 1}^{′}} \\ ⋮ & ⋮ & ⋱ & ⋮ \\ {p}_{2 L - 1 , 0}^{′} {e}^{j {ϕ}_{2 L - 1 , 0}^{′}} & {p}_{2 L - 1 , 1}^{′} {e}^{j {ϕ}_{2 L - 1 , 1}^{′}} & … & {p}_{2 L - 1 , 1}^{′} {e}^{j {ϕ}_{2 L - 1 , M - 1}^{′}}\end{matrix} ]$

A UE, such as UE 115 (FIGS. 5-8), within the CSI report, such as CSI reports 404 and 600, the index of the strongest coefficient (SCI), a 4-bit quantization of the reference power, p_{ref}, for the weaker polarizations, a 3-bit quantization of the differential amplitude, p_{L+1,M-1} or p′_{L+1,M-1}, and a phase quantization, e^{jϕ}^{_{L+1,M−1}} or e^{jϕ′}^{_{L+1,M−1}}, quantized using a favorable quantization, such as a high order phase shift keying (PSK) (e.g., 8PSK, 16PSK, etc.), differential PSK (DPSK), or the like.

Referring back to FIG. 4, the various aspects of the present disclosure may provide for the CSI feedback for the spatial- and frequency domains and the CSI feedback for the time domain to be transmitted at different fields or portions within the same CSI report, such as CSI report 404. Alternative aspects of the present disclosure may provide for the spatial- and frequency domain CSI feedback to be transmitted in a first CSI report, such as CSI report 404, while the time domain CSI feedback may be transmitted by UE 115 in a second CSI report, such as CSI report 406, in which CSI report 406 includes a linkage reference to the spatial- and frequency domain CSI feedback in CSI report 404. Base station 105 may then combine the CSI feedback for each of the spatial-, frequency-, and time domains to adjust the transmission characteristics for communications between base station 105 and UE 115.

It is noted that one or more blocks (or operations) described with reference to FIG. 5 may be combined with one or more blocks (or operations) described with reference to another of the figures. For example, one or more blocks (or operations) of FIG. 7 may be combined with one or more blocks (or operations) of FIG. 6. As another example, one or more blocks associated with FIG. 5 may be combined with one or more blocks associated with FIG. 4. As another example, one or more blocks associated with FIG. 5 may be combined with one or more blocks (or operations) associated with FIGS. 1-2. Additionally, or alternatively, one or more operations described above with reference to FIGS. 1-2 may be combined with one or more operations described with reference to FIGS. 5 and 8.

In one or more aspects, techniques for supporting selection and quantization of time domain coefficients through an extended eType-II codebook according to one or more aspects of the present disclosure may include additional aspects, such as any single aspect or any combination of aspects described below or in connection with one or more other processes or devices described elsewhere herein. In one or more aspects, supporting selection and quantization of time domain coefficients through an extended eType-II codebook according to one or more aspects of the present disclosure may include a UE configured to measure a bundle of CSI-RS to determine channel quality information across a spatial domain, a frequency domain, and a time domain and generate a first bitmap identifying a first plurality of NZCs selected to represent a first CSI for the spatial domain and the frequency domain, and a second bitmap identifying a second plurality of NZCs selected to represent a second CSI for the time domain. The UE may then transmit one or more CSI reports including one or both of the first bitmap and the second bitmap.

Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

A first aspect of the present disclosure includes wireless communication performed by a UE including measuring, by the UE, a bundle of CSI-RS to determine channel quality information across a spatial domain, a frequency domain, and a time domain; generating, by the UE, a first bitmap identifying a first plurality of NZCs selected to represent a first CSI for the spatial domain and the frequency domain, and a second bitmap identifying a second plurality of NZCs selected to represent a second CSI for the time domain; and transmitting, by the UE, one or more CSI reports including one or both of the first bitmap and the second bitmap.

In a second aspect, alone or in combination with the first aspect, wherein the generating the second bitmap includes: selecting each NZC of the second plurality of NZCs on a per beam and per delay manner; and generating the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

In a third aspect, alone or in combination with one or more of the first aspect and the second aspect, wherein the generating the second bitmap includes: selecting each NZC of the second plurality of NZCs on a per beam manner; and generating the second bitmap identifying the second plurality of NZCs, wherein the second bitmap corresponds to L_{NZ}^{tot}(D−1) bits, where L_{NZ}^{tot} represents a total number of beams that is associated with at least one NZC of the first plurality of NZCs, selected for a total number of beams, L, configured in the spatial domain for the first plurality of NZCs across all layers, and D represents a total number of time domain bases configured in the time domain.

In a fourth aspect, alone or in combination with one or more of the first aspect through the third aspect, wherein the generating the second bitmap includes: selecting each NZC of the second plurality of NZCs on a per delay manner; and generating the second bitmap identifying the second plurality of NZCs, wherein the second bitmap corresponds to M_{NZ}^{tot}(D−1) bits, where M_{NZ}^{tot} represents a total number of delays that is associated with at least one NZC of the first plurality of NZCs selected for a total number of delays, M, configured in the frequency domain for the first plurality of NZCs across all layers, and D represents a total number of time domain bases configured in the time domain.

In a fifth aspect, alone or in combination with one or more of the first aspect through the fourth aspect, wherein the generating the second bitmap includes: selecting an NZC of the second plurality of NZCs for each time domain basis of a total number of time domain bases, D, configured in the time domain, wherein the NZC of the second plurality of NZCs is selected according to any NZC selected in one of a beam configured in the spatial domain within a corresponding time domain basis or a delay configured in the frequency domain within the corresponding time domain basis; and generating the second bitmap identifying the second plurality of NZCs, wherein the second bitmap corresponds to (D−1) bits.

In a sixth aspect, alone or in combination with one or more of the first aspect through the fifth aspect, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

In a seventh aspect, alone or in combination with one or more of the first aspect through the sixth aspect, further comprising: identifying, by the UE, a strongest coefficient of the second plurality of NZCs across a total number of time domain bases, D, configured in the time domain; and aligning, by the UE, the strongest coefficient to be associated with a zero-Doppler time domain basis of the total number of time domain bases, D, wherein the one or more CSI reports further includes a SCI identifying the strongest coefficient is associated with the zero-Doppler time domain basis.

In an eighth aspect, alone or in combination with one or more of the first aspect, through the seventh aspect, further comprising: identifying, by the UE, the strongest coefficient having a strongest polarization of a plurality of zero-Doppler NZCs identified for the zero-Doppler time domain basis; assigning, by the UE, a fixed reference amplitude to each NZC of the second plurality of NZCs associated with a non-strongest polarization across the total number of time domain bases, D; and defining, by the UE, a differential amplitude quantization for each additional NZC of the second plurality of NZCs other than the plurality of zero-Doppler NZCs, wherein the differential amplitude quantization in is relation to an amplitude of the strongest coefficient, wherein the one or more CSI reports further include the fixed reference amplitude for the each additional NZC quantized to a first number of bits, and the differential amplitude quantization for the each additional NZC quantized to a second number of bits.

In a ninth aspect, alone or in combination with one or more of the first aspect through the eighth aspect, wherein the one or more CSI reports includes one of: one CSI report including the first bitmap in a first field of the one CSI report and the second bitmap in a second field of the one CSI report; or a first CSI report including the first bitmap and a second CSI report including the second bitmap and a reference indicator to the first CSI report.

A tenth aspect, configured for wireless communication, includes a UE having at least one processor; and a memory coupled to the at least one processor, wherein the at least one processor is configured: to measure, by the UE, a bundle of CSI-RS to determine channel quality information across a spatial domain, a frequency domain, and a time domain; to generate, by the UE, a first bitmap identifying a first plurality of NZCs selected to represent a first CSI for the spatial domain and the frequency domain, and a second bitmap identifying a second plurality of NZCs selected to represent a second CSI for the time domain; and to transmit, by the UE, one or more CSI reports including one or both of the first bitmap and the second bitmap.

In an eleventh aspect, alone or in combination with the tenth aspect, wherein the configuration of the at least one processor to generate the second bitmap includes configuration of the at least one processor: to select each NZC of the second plurality of NZC's on a per beam and per delay manner; and to generate the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

In a twelfth aspect, alone or in combination with one or more of the tenth aspect and the eleventh aspect, wherein the configuration of the at least one processor to generate the second bitmap includes configuration of the at least one processor: to select each NZC of the second plurality of NZCs on a per beam manner; and to generate the second bitmap identifying the second plurality of NZCs, wherein the second bitmap corresponds to L_{NZ}^{tot}(D−1) bits, where L_{NZ}^{tot} represents a total number of beams that is associated with at least one NZC of the first plurality of NZCs, selected for a total number of beams, L, configured in the spatial domain for the first plurality of NZCs across all layers, and D represents a total number of time domain bases configured in the time domain.

In a thirteenth aspect, alone or in combination with one or more of the tenth aspect through the twelfth aspect, wherein the configuration of the at least one processor to generate the second bitmap includes configuration of the at least one processor: to select each NZC of the second plurality of NZCs on a per delay manner; and to generate the second bitmap identifying the second plurality of NZCs, wherein the second bitmap corresponds to M_{NZ}^{tot}(D−1) bits, where M_{NZ}^{tot} represents a total number of delays that is associated with at least one NZC of the first plurality of NZCs selected for a total number of delays, M, configured in the frequency domain for the first plurality of NZCs across all layers, and D represents a total number of time domain bases configured in the time domain.

In a fourteenth aspect, alone or in combination with one or more of the tenth aspect through the thirteenth aspect, wherein the configuration of the at least one processor to generate the second bitmap includes configuration of the at least one processor: to select an NZC of the second plurality of NZCs for each time domain basis of a total number of time domain bases, D, configured in the time domain, wherein the NZC of the second plurality of NZCs is selected according to any NZC selected in one of a beam configured in the spatial domain within a corresponding time domain basis or a delay configured in the frequency domain within the corresponding time domain basis; and to generate the second bitmap identifying the second plurality of NZCs, wherein the second bitmap corresponds to (D−1) bits.

In a fifteenth aspect, alone or in combination with one or more of the tenth aspect through the fourteenth aspect, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

In a sixteenth aspect, alone or in combination with one or more of the tenth aspect through the fifteenth aspect, further comprising configuration of the at least one processor: to identify, by the UE, a strongest coefficient of the second plurality of NZCs across a total number of time domain bases, D, configured in the time domain; and to align, by the UE, the strongest coefficient to be associated with a zero-Doppler time domain basis of the total number of time domain bases, D, wherein the one or more CSI reports further includes a SCI identifying the strongest coefficient is associated with the zero-Doppler time domain basis.

In a seventeenth aspect, alone or in combination with one or more of the tenth aspect through the sixteenth aspect, further comprising configuration of the at least one processor: to identify, by the UE, the strongest coefficient having a strongest polarization of a plurality of zero-Doppler NZCs identified for the zero-Doppler time domain basis; to assign, by the UE, a fixed reference amplitude to each NZC of the second plurality of NZCs associated with a non-strongest polarization across the total number of time domain bases, D; and to define, by the UE, a differential amplitude quantization for each additional NZC of the second plurality of NZCs other than the plurality of zero-Doppler NZCs, wherein the differential amplitude quantization in is relation to an amplitude of the strongest coefficient, wherein the one or more CSI reports further include the fixed reference amplitude for the each additional NZC quantized to a first number of bits, and the differential amplitude quantization for the each additional NZC quantized to a second number of bits.

In an eighteenth aspect, alone or in combination with one or more of the tenth aspect through the seventeenth aspect, wherein the one or more CSI reports includes one of: one CSI report including the first bitmap in a first field of the one CSI report and the second bitmap in a second field of the one CSI report; or a first CSI report including the first bitmap and a second CSI report including the second bitmap and a reference indicator to the first CSI report.

A nineteenth aspect comprises a UE configured for wireless communication including means for measuring, by the UE, a bundle of CSI-RS to determine channel quality information across a spatial domain, a frequency domain, and a time domain; means for generating, by the UE, a first bitmap identifying a first plurality of NZCs selected to represent a first CSI for the spatial domain and the frequency domain, and a second bitmap identifying a second plurality of NZCs selected to represent a second CSI for the time domain; and means for transmitting, by the UE, one or more CSI reports including one or both of the first bitmap and the second bitmap.

In a twentieth aspect, alone or in combination with the nineteenth aspect, wherein the means for generating the second bitmap includes: means for selecting each NZC of the second plurality of NZCs on a per beam and per delay manner; and means for generating the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

In a twenty-first aspect, alone or in combination with one or more of the nineteenth aspect and the twentieth aspect, wherein the means for generating the second bitmap includes: means for selecting each NZC of the second plurality of NZCs on a per beam manner; and means for generating the second bitmap identifying the second plurality of NZCs, wherein the second bitmap corresponds to L_{NZ}^{tot}(D−1) bits, where L_{NZ}^{tot} represents a total number of beams that is associated with at least one NZC of the first plurality of NZCs, selected for a total number of beams, L, configured in the spatial domain for the first plurality of NZCs across all layers, and D represents a total number of time domain bases configured in the time domain.

In a twenty-second aspect, alone or in combination with one or more of the nineteenth aspect through the twenty-first aspect, wherein the means for generating the second bitmap includes: means for selecting each NZC of the second plurality of NZCs on a per delay manner; and means for generating the second bitmap identifying the second plurality of NZCs, wherein the second bitmap corresponds to M_{NZ}^{tot}(D−1) bits, where M_{NZ}^{tot} represents a total number of delays that is associated with at least one NZC of the first plurality of NZCs selected for a total number of delays, M, configured in the frequency domain for the first plurality of NZCs across all layers, and D represents a total number of time domain bases configured in the time domain.

In a twenty-third aspect, alone or in combination with one or more of the nineteenth aspect through the twenty-second aspect, wherein the means for generating the second bitmap includes: means for selecting an NZC of the second plurality of NZCs for each time domain basis of a total number of time domain bases, D, configured in the time domain, wherein the NZC of the second plurality of NZCs is selected according to any NZC selected in one of a beam configured in the spatial domain within a corresponding time domain basis or a delay configured in the frequency domain within the corresponding time domain basis; and means for generating the second bitmap identifying the second plurality of NZCs, wherein the second bitmap corresponds to (D−1) bits.

In a twenty-fourth aspect, alone or in combination with one or more of the nineteenth aspect through the twenty-third aspect, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

In a twenty-fifth aspect, alone or in combination with one or more of the nineteenth aspect through the twenty-third aspect, further comprising: means for identifying, by the UE, a strongest coefficient of the second plurality of NZCs across a total number of time domain bases, D, configured in the time domain; and means for aligning, by the UE, the strongest coefficient to be associated with a zero-Doppler time domain basis of the total number of time domain bases, D, wherein the one or more CSI reports further includes a SCI identifying the strongest coefficient is associated with the zero-Doppler time domain basis.

In a twenty-sixth aspect, alone or in combination with one or more of the nineteenth aspect through the twenty-fifth aspect, further comprising: means for identifying, by the UE, the strongest coefficient having a strongest polarization of a plurality of zero-Doppler NZCs identified for the zero-Doppler time domain basis; means for assigning, by the UE, a fixed reference amplitude to each NZC of the second plurality of NZCs associated with a non-strongest polarization across the total number of time domain bases, D; and means for defining, by the UE, a differential amplitude quantization for each additional NZC of the second plurality of NZCs other than the plurality of zero-Doppler NZCs, wherein the differential amplitude quantization in is relation to an amplitude of the strongest coefficient, wherein the one or more CSI reports further include the fixed reference amplitude for the each additional NZC quantized to a first number of bits, and the differential amplitude quantization for the each additional NZC quantized to a second number of bits.

In a twenty-seventh aspect, alone or in combination with one or more of the nineteenth aspect through the twenty-sixth aspect, wherein the one or more CSI reports includes one of: one CSI report including the first bitmap in a first field of the one CSI report and the second bitmap in a second field of the one CSI report; or a first CSI report including the first bitmap and a second CSI report including the second bitmap and a reference indicator to the first CSI report.

A twenty-eighth aspect includes a UE having a non-transitory computer-readable medium having program code recorded thereon. The program code includes program code executable by a computer for causing the computer to measure, by the UE, a bundle of CSI-RS to determine channel quality information across a spatial domain, a frequency domain, and a time domain; program code executable by the computer for causing the computer to generate, by the UE, a first bitmap identifying a first plurality of NZCs selected to represent a first CSI for the spatial domain and the frequency domain, and a second bitmap identifying a second plurality of NZCs selected to represent a second CSI for the time domain; and program code executable by the computer for causing the computer to transmit, by the UE, one or more CSI reports including one or both of the first bitmap and the second bitmap.

In a twenty-ninth aspect, alone or in combination with the twenty-eighth aspect, wherein the program code executable by the computer for causing the computer to generate the second bitmap includes program code executable by the computer for causing the computer: to select each NZC of the second plurality of NZCs on a per beam and per delay manner; and to generate the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

In a thirtieth aspect, alone or in combination with one or more of the twenty-eighth aspect and the twenty-ninth aspect, wherein the program code executable by the computer for causing the computer to generate the second bitmap includes program code executable by the computer for causing the computer: to select each NZC of the second plurality of NZCs on a per beam manner; and to generate the second bitmap identifying the second plurality of NZCs, wherein the second bitmap corresponds to L_{NZ}^{tot}(D−1) bits, where L_{NZ}^{tot} represents a total number of beams that is associated with at least one NZC of the first plurality of NZCs, selected for a total number of beams, L, configured in the spatial domain for the first plurality of NZCs across all layers, and D represents a total number of time domain bases configured in the time domain.

In a thirty-first aspect, alone or in combination with one or more of the twenty-eighth aspect through the thirtieth aspect, wherein the program code executable by the computer for causing the computer to generate the second bitmap includes program code executable by the computer for causing the computer: to select each NZC of the second plurality of NZCs on a per delay manner; and to generate the second bitmap identifying the second plurality of NZCs, wherein the second bitmap corresponds to M_{NZ}^{tot}(D−1) bits, where M_{NZ}^{tot} represents a total number of delays that is associated with at least one NZC of the first plurality of NZCs selected for a total number of delays, M, configured in the frequency domain for the first plurality of NZCs across all layers, and D represents a total number of time domain bases configured in the time domain.

In a thirty-second aspect, alone or in combination with one or more of the twenty-cighth aspect through the thirty-first aspect, wherein the program code executable by the computer for causing the computer to generate the second bitmap includes program code executable by the computer for causing the computer: to select an NZC of the second plurality of NZCs for each time domain basis of a total number of time domain bases, D, configured in the time domain, wherein the NZC of the second plurality of NZCs is selected according to any NZC selected in one of a beam configured in the spatial domain within a corresponding time domain basis or a delay configured in the frequency domain within the corresponding time domain basis; and to generate the second bitmap identifying the second plurality of NZCs, wherein the second bitmap corresponds to (D−1) bits.

In a thirty-third aspect, alone or in combination with one or more of the twenty-eighth aspect through the thirty-second aspect, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

In a thirty-fourth aspect, alone or in combination with one or more of the twenty-eighth aspect through the thirty-third aspect, further comprising program code executable by the computer for causing the computer: to identify, by the UE, a strongest coefficient of the second plurality of NZCs across a total number of time domain bases, D, configured in the time domain; and to align, by the UE, the strongest coefficient to be associated with a zero-Doppler time domain basis of the total number of time domain bases, D, wherein the one or more CSI reports further includes a SCI identifying the strongest coefficient is associated with the zero-Doppler time domain basis.

In a thirty-fifth aspect, alone or in combination with one or more of the twenty-eighth aspect through the thirty-fourth aspect, further comprising program code executable by the computer for causing the computer: to identify, by the UE, the strongest coefficient having a strongest polarization of a plurality of zero-Doppler NZCs identified for the zero-Doppler time domain basis; to assign, by the UE, a fixed reference amplitude to each NZC of the second plurality of NZCs associated with a non-strongest polarization across the total number of time domain bases, D; and to define, by the UE, a differential amplitude quantization for each additional NZC of the second plurality of NZCs other than the plurality of zero-Doppler NZCs, wherein the differential amplitude quantization in is relation to an amplitude of the strongest coefficient, wherein the one or more CSI reports further include the fixed reference amplitude for the each additional NZC quantized to a first number of bits, and the differential amplitude quantization for the each additional NZC quantized to a second number of bits.

In a thirty-sixth aspect, alone or in combination with one or more of the twenty-eighth aspect through the thirty-fifth aspect, wherein the one or more CSI reports includes one of: one CSI report including the first bitmap in a first field of the one CSI report and the second bitmap in a second field of the one CSI report; or a first CSI report including the first bitmap and a second CSI report including the second bitmap and a reference indicator to the first CSI report.

The various aspects of the present disclosure may be implemented in many different ways, including methods, processes, non-transitory computer-readable medium having program code recorded thereon, apparatus having one or more processors with configurations and instructions for performing the described features and functionality, and the like.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically crasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
measuring, by the UE, a bundle of channel state information (CSI) reference signals (CSI-RS) to determine channel quality information across a spatial domain, a frequency domain, and a time domain;
generating, by the UE, a first bitmap identifying a first plurality of non-zero coefficients (NZCs) selected to represent a first CSI for the spatial domain and the frequency domain, and a second bitmap identifying a second plurality of NZCs selected to represent a second CSI for the time domain; and
transmitting, by the UE, one or more CSI reports including one or both of the first bitmap and the second bitmap.

2. The method of claim 1, wherein the generating the second bitmap includes:
selecting each NZC of the second plurality of NZCs on a per beam and per delay manner; and
generating the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

3. The method of claim 1, wherein the first bitmap corresponds to 2LM bits per layer, where L corresponds to a total number of beams and M represents a total number of delays configured in the frequency domain.

4. The method of claim 1, wherein the first bitmap is associated with a zero-Doppler time domain basis.

5. The method of claim 1, wherein the second bitmap is associated with one or more non-zero-Doppler time domain basis.

6. The method of claim 1, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

7. The method of claim 1, further comprising:
identifying, by the UE, a strongest coefficient of the second plurality of NZCs across a total number of time domain bases, D, configured in the time domain; and
aligning, by the UE, the strongest coefficient to be associated with a zero-Doppler time domain basis of the total number of time domain bases, D,
wherein the one or more CSI reports further includes a strongest coefficient indicator (SCI) identifying the strongest coefficient is associated with the zero-Doppler time domain basis.

8. The method of claim 7, further comprising:
identifying, by the UE, the strongest coefficient having a strongest polarization of a plurality of zero-Doppler NZCs identified for the zero-Doppler time domain basis;
assigning, by the UE, a fixed reference amplitude to each NZC of the second plurality of NZCs associated with a non-strongest polarization across the total number of time domain bases, D; and
defining, by the UE, a differential amplitude quantization for each additional NZC of the second plurality of NZCs other than the plurality of zero-Doppler NZCs, wherein the differential amplitude quantization in is relation to an amplitude of the strongest coefficient,
wherein the one or more CSI reports further include the fixed reference amplitude for the each additional NZC quantized to a first number of bits, and the differential amplitude quantization for the each additional NZC quantized to a second number of bits.

9. The method of claim 1, wherein the one or more CSI reports includes one of:
one CSI report including the first bitmap in a first field of the one CSI report and the second bitmap in a second field of the one CSI report; or
a first CSI report including the first bitmap and a second CSI report including the second bitmap and a reference indicator to the first CSI report.

10. A user equipment (UE) configured for wireless communication, the UE comprising:
at least one processor; and
a memory coupled to the at least one processor,
wherein the at least one processor is configured:
to measure, by the UE, a bundle of channel state information (CSI) reference signals (CSI-RS) to determine channel quality information across a spatial domain, a frequency domain, and a time domain;
to generate, by the UE, a first bitmap identifying a first plurality of non-zero coefficients (NZCs) selected to represent a first CSI for the spatial domain and the frequency domain, and a second bitmap identifying a second plurality of NZCs selected to represent a second CSI for the time domain; and
to transmit, by the UE, one or more CSI reports including one or both of the first bitmap and the second bitmap.

11. The UE of claim 10, wherein the configuration of the at least one processor to generate the second bitmap includes configuration of the at least one processor:
to select each NZC of the second plurality of NZCs on a per beam and per delay manner; and
to generate the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

12. The UE of claim 10, wherein the first bitmap corresponds to 2LM bits per layer, where L corresponds to a total number of beams and M represents a total number of delays configured in the frequency domain.

13. The UE of claim 10, wherein the first bitmap is associated with a zero-Doppler time domain basis.

14. The UE of claim 10, wherein the second bitmap is associated with one or more non-zero-Doppler time domain basis.

15. The UE of claim 10, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

16. The UE of claim 10, further comprising configuration of the at least one processor:
to identify, by the UE, a strongest coefficient of the second plurality of NZCs across a total number of time domain bases, D, configured in the time domain; and
to align, by the UE, the strongest coefficient to be associated with a zero-Doppler time domain basis of the total number of time domain bases, D,
wherein the one or more CSI reports further includes a strongest coefficient indicator (SCI) identifying the strongest coefficient is associated with the zero-Doppler time domain basis.

17. The UE of claim 16, further comprising configuration of the at least one processor:
to identify, by the UE, the strongest coefficient having a strongest polarization of a plurality of zero-Doppler NZCs identified for the zero-Doppler time domain basis;
to assign, by the UE, a fixed reference amplitude to each NZC of the second plurality of NZCs associated with a non-strongest polarization across the total number of time domain bases, D; and
to define, by the UE, a differential amplitude quantization for each additional NZC of the second plurality of NZCs other than the plurality of zero-Doppler NZCs, wherein the differential amplitude quantization in is relation to an amplitude of the strongest coefficient,
wherein the one or more CSI reports further include the fixed reference amplitude for the each additional NZC quantized to a first number of bits, and the differential amplitude quantization for the each additional NZC quantized to a second number of bits.

18. The UE of claim 10, wherein the one or more CSI reports includes one of:
one CSI report including the first bitmap in a first field of the one CSI report and the second bitmap in a second field of the one CSI report; or
a first CSI report including the first bitmap and a second CSI report including the second bitmap and a reference indicator to the first CSI report.

19. A user equipment (UE) configured for wireless communication, comprising:
means for measuring, by the UE, a bundle of channel state information (CSI) reference signals (CSI-RS) to determine channel quality information across a spatial domain, a frequency domain, and a time domain;
means for generating, by the UE, a first bitmap identifying a first plurality of non-zero coefficients (NZCs) selected to represent a first CSI for the spatial domain and the frequency domain, and a second bitmap identifying a second plurality of NZCs selected to represent a second CSI for the time domain; and
means for transmitting, by the UE, one or more CSI reports including one or both of the first bitmap and the second bitmap.

20. The UE of claim 19, wherein the means for generating the second bitmap includes:
means for selecting each NZC of the second plurality of NZCs on a per beam and per delay manner; and
means for generating the second bitmap identifying the second plurality of NZCs, wherein the second bitmap corresponds to K_{NZ}^{tot}(D−1) bits, where K_{NZ}^{tot} represents a total number of NZCs selected for the first plurality of NZCs across all layers, and D represents a total number of time domain bases configured in the time domain.

21. The UE of claim 19, wherein the first bitmap corresponds to 2LM bits per layer, where L corresponds to a total number of beams and M represents a total number of delays configured in the frequency domain.

22. The UE of claim 19, wherein the first bitmap is associated with a zero-Doppler time domain basis.

23. The UE of claim 19, wherein the second bitmap is associated with one or more non-zero-Doppler time domain basis.

24. The UE of claim 19, wherein the second bitmap corresponds to 2LM(D−1) bits per layer, where L represents a total number of beams configured in the spatial domain, M represents a total number of delays configured in the frequency domain, and D represents a total number of time domain bases configured in the time domain.

25. The UE of claim 19, further comprising:
means for identifying, by the UE, a strongest coefficient of the second plurality of NZCs across a total number of time domain bases, D, configured in the time domain; and
means for aligning, by the UE, the strongest coefficient to be associated with a zero-Doppler time domain basis of the total number of time domain bases, D,
wherein the one or more CSI reports further includes a strongest coefficient indicator (SCI) identifying the strongest coefficient is associated with the zero-Doppler time domain basis.

26. The UE of claim 25, further comprising:
means for identifying, by the UE, the strongest coefficient having a strongest polarization of a plurality of zero-Doppler NZCs identified for the zero-Doppler time domain basis;
means for assigning, by the UE, a fixed reference amplitude to each NZC of the second plurality of NZCs associated with a non-strongest polarization across the total number of time domain bases, D; and
means for defining, by the UE, a differential amplitude quantization for each additional NZC of the second plurality of NZCs other than the plurality of zero-Doppler NZCs, wherein the differential amplitude quantization in is relation to an amplitude of the strongest coefficient,
wherein the one or more CSI reports further include the fixed reference amplitude for the each additional NZC quantized to a first number of bits, and the differential amplitude quantization for the each additional NZC quantized to a second number of bits.

27. The UE of claim 19, wherein the one or more CSI reports includes one of:
one CSI report including the first bitmap in a first field of the one CSI report and the second bitmap in a second field of the one CSI report; or
a first CSI report including the first bitmap and a second CSI report including the second bitmap and a reference indicator to the first CSI report.

28. A non-transitory computer-readable medium having program code recorded thereon, the program code comprising:
program code executable by a computer for causing the computer to measure, by a user equipment (UE), a bundle of channel state information (CSI) reference signals (CSI-RS) to determine channel quality information across a spatial domain, a frequency domain, and a time domain;
program code executable by the computer for causing the computer to generate, by the UE, a first bitmap identifying a first plurality of non-zero coefficients (NZCs) selected to represent a first CSI for the spatial domain and the frequency domain, and a second bitmap identifying a second plurality of NZCs selected to represent a second CSI for the time domain; and
program code executable by the computer for causing the computer to transmit, by the UE, one or more CSI reports including one or both of the first bitmap and the second bitmap.

29. The non-transitory computer-readable medium of claim 28, further comprising program code executable by the computer for causing the computer:
to identify, by the UE, a strongest coefficient of the second plurality of NZCs across a total number of time domain bases, D, configured in the time domain; and
to align, by the UE, the strongest coefficient to be associated with a zero-Doppler time domain basis of the total number of time domain bases, D,
wherein the one or more CSI reports further includes a strongest coefficient indicator (SCI) identifying the strongest coefficient is associated with the zero-Doppler time domain basis.

30. The non-transitory computer-readable medium of claim 28, wherein the one or more CSI reports includes one of:
one CSI report including the first bitmap in a first field of the one CSI report and the second bitmap in a second field of the one CSI report; or
a first CSI report including the first bitmap and a second CSI report including the second bitmap and a reference indicator to the first CSI report.
